(19) United States
(12) Patent Application Publication
(10) Pub. No.: US 2002/0142830 A1
(43) Pub. Date: Oct. 3, 2002

(54) Gaming device with interactive electroluminescent display

(76) Inventor: William R. Adams, Las Vegas, NV (US)

Correspondence Address: MARSHALL, GERSTEIN & BORUN, 6300 SEARS TOWER, 233 SOUTH WACKER, CHICAGO, IL, 60606-6357, US

(21) Appl. No.: 10/145,260

(22) Filed: May 14, 2002

Related U.S. Application Data
(63) Continuation of application No. 09/159,185, filed on Sep. 23, 1998.

(51) Int. Cl. A63F 13/00

(52) U.S. Cl. 463/20; 463/30

(57) ABSTRACT

Gaming devices with electroluminescent illumination displays wherein the state of the electroluminescent display changed in response to active input by a player and/or events occurring during the play of the game.

The present invention is directed to gaming devices and, more particularly to gaming devices comprising interactive electroluminescent lighting displays.

### BACKGROUND

Gaming devices, known in the art, are typically illuminated, while they are being played, and sometimes in an “attract mode”. The “Attract mode” is typically a repetitive sequence which is designed to attract potential players and passers-by to play the gaming device. Providing flashing lights and sounds in response to different events occurring during the play of a gaming device is also known.

Electroluminescent lamps have been utilized for different types of lighting such as point-of-purchase advertising displays. Electroluminescent lamps are desirable as they provide a very attractive form of lighting. Since previously known uses of electroluminescence have typically been in an attract mode, it would be desirable to utilize the desirable aspects of electroluminescent lights in a more interactive form with gaming devices.

### SUMMARY OF THE INVENTION

Various embodiments of the present invention provide gaming devices with at least one electroluminescent display wherein the electroluminescent display is changed in response to active input by a player and/or events occurring during the play of the game. For example, the electroluminescent lighting displays can be changed within the scope of the present invention in response to the amount of a wager by a player, e.g. the placement of a maximum wager by a player, upon the occurrence of a certain outcome on a primary, secondary and/or subsequent random event, upon receiving certain input from a player, to indicate the status of features of a game such as the paylines on a multiple payline slot machine, highlighting a particular game even or game payout, the activation of a secondary event, etc. As used herein, the word “changed” when used in reference to the state of an electroluminescent display device indicates that the display is extinguished, illuminated, and/or the illumination is modified, for example made brighter or dimmer.

### BRIEF DESCRIPTION OF THE DRAWINGS

FIG. 1 illustrates an electroluminescent payline used with one embodiment of the present invention.

FIG. 2 illustrates one embodiment of the present invention.

FIG. 3 illustrates a status display of one embodiment of the present invention.

FIG. 4 illustrates a payout indicator of another embodiment of the present invention.

### DETAILED DESCRIPTION

The various embodiments of the present invention combine the attractive features of electroluminescent lighting devices with the interactive excitement of gaming devices by providing gaming devices with interactive electroluminescent lighting which changes in response to active input by a player and/or events occurring during the play of the game, i.e. during the play mode of a gaming device. As used herein, the term “play mode” is meant to distinguish the active play of a gaming device from an “attract mode” wherein a game may be on a preprogrammed, continuous and/or repetitive lighting, sound, or demo sequence prior to the commencement of an actual game in order to attract players and potential players.

According to various embodiments of the present invention, electroluminescent lighting is changed in response to active input by a player or in response to events occurring during the play of a game. As used herein, the term “active input” is meant to indicate a conscious decision by a player which is intended to or has the ability to affect the outcome of game. “Active input”, as used herein, does not include the initial decision of a player to simply play a particular game or gaming device, or the act of wagering the minimum wager required by the game or gaming device to initiate play. For example, the electroluminescent lighting displays can be changed within the scope of the present invention in response to the input of a player to hold certain cards, the input of a player to affect other indicia of a game such as selecting from available options, upon receiving certain other input from a player, the wagering of a predetermined amount such as a maximum wager or a wager above some predetermined amount by a player, the occurrence of a certain outcome on a primary, secondary or subsequent random event, to indicate the status of features of a game such as the active paylines on a multiple payline slot machine or in conjunction with other intermediate or final events occurring during the play or at the end of a game.

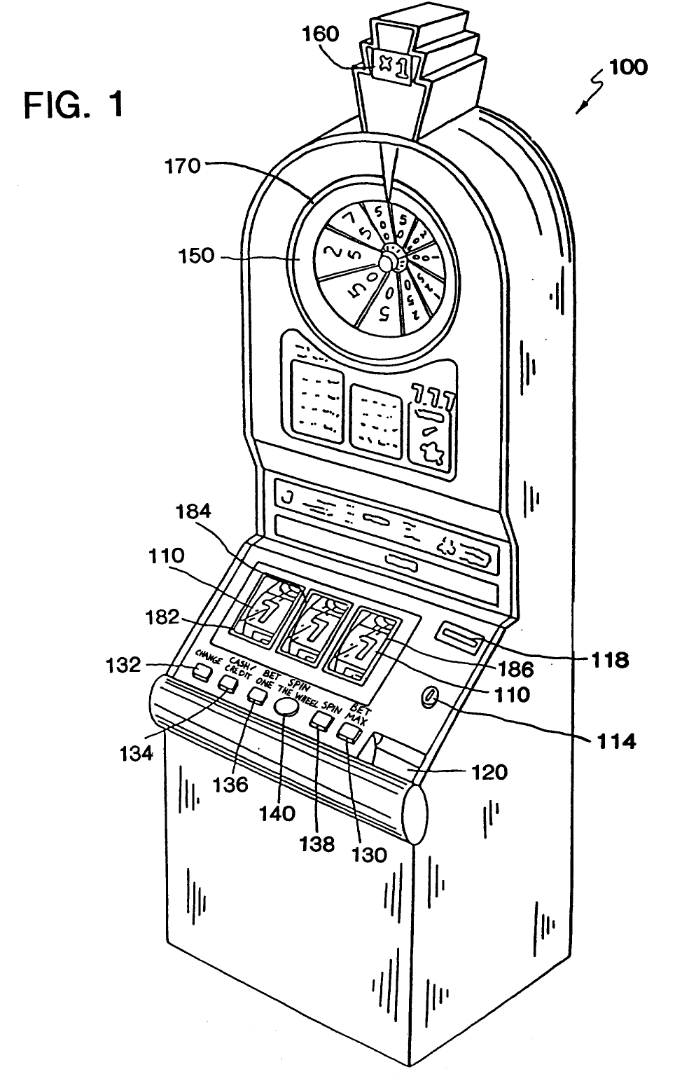

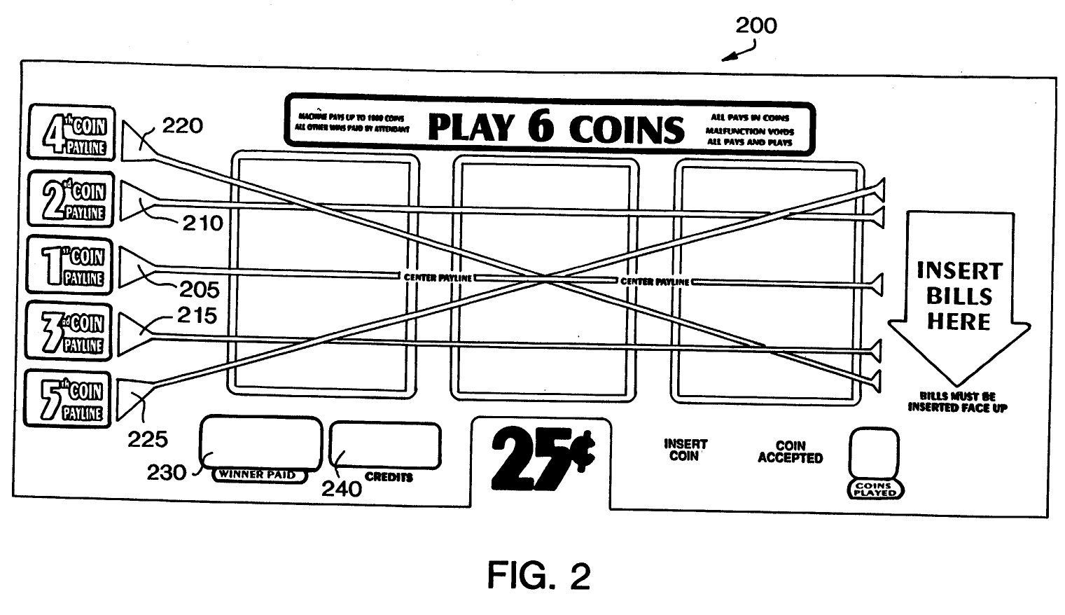

FIG. 2 illustrates one embodiment of the present invention, through from the present description, those skilled in the art will appreciate that alternative embodiments may be utilized without departing from the scope of the present invention. The embodiment illustrated in FIG. 1 comprises a gaming device 100 with a primary gaming unit comprising a three-reel slot machine having primary display 110, control buttons including BET MAX button 130, CHANGE button 132, CASH/CREDIT button 134, BET ONE button 136, SPIN button 138, and SPIN THE WHEEL button 140. In addition, a coin slot 114, currency validator 118 and payout chute 120 are provided. Additionally a secondary event display 150 and a multiplier 160 are provided. While the illustrated gambling device is a very popular gambling device with a secondary event, the advantages of the present invention can be enjoyed with gambling devices of other forms, including those without secondary events.

In accordance with this illustrated embodiment, electroluminescent lighting displays are provided in a ring 170 around the secondary event indicator, in a loop 182 around the left reel, a loop 184 around the center reel and a loop 186 around the right reel. These electroluminescent lighting displays are changed when the secondary event is activated and/or when a predetermined symbol is displayed on one of the reel displays.

According to another preferred embodiment of the present invention, different paylines are provided with different electroluminescent lighting displays. FIG. 2 illustrates a reel-type display 200 with five paylines. A first electroluminescent lighting display 205 illuminates a first payline in a first color, a second electroluminescent lighting display 210 illuminates a second payline in a second color, a third electroluminescent lighting display 215 illuminates a third payline in a third color, a fourth electroluminescent lighting display 220 illuminates a fourth payline in a fourth color, and a fifth electroluminescent lighting display 225 illuminates a fifth payline in a fifth color. These different paylines are illuminated in response to different images place by a player. Additionally, the WINNER PAID window 230 and CREDITS window 240 can also be provided with electroluminescent lighting display. According to one preferred embodiment of the present invention, at least one electroluminescent lighting device is illuminated in order to indicate the paylines which are active.

According to another embodiment of the present invention, one or more electroluminescent lighting devices are illuminated and extinguished in sequence when a player obtains at least one of a plurality of outcomes on said gaming device. For example, if a player attains a certain payout, then one, and preferably a plurality of electroluminescent devices are illuminated and extinguished in sequence. According to an alternative embodiment of the present invention, the state of the electroluminescent display device can be randomly controlled during the play of a gaming device. While this illustrated embodiment comprises five paylines with five different colors, the advantages of this aspect of the present invention can be realized with two or more paylines.

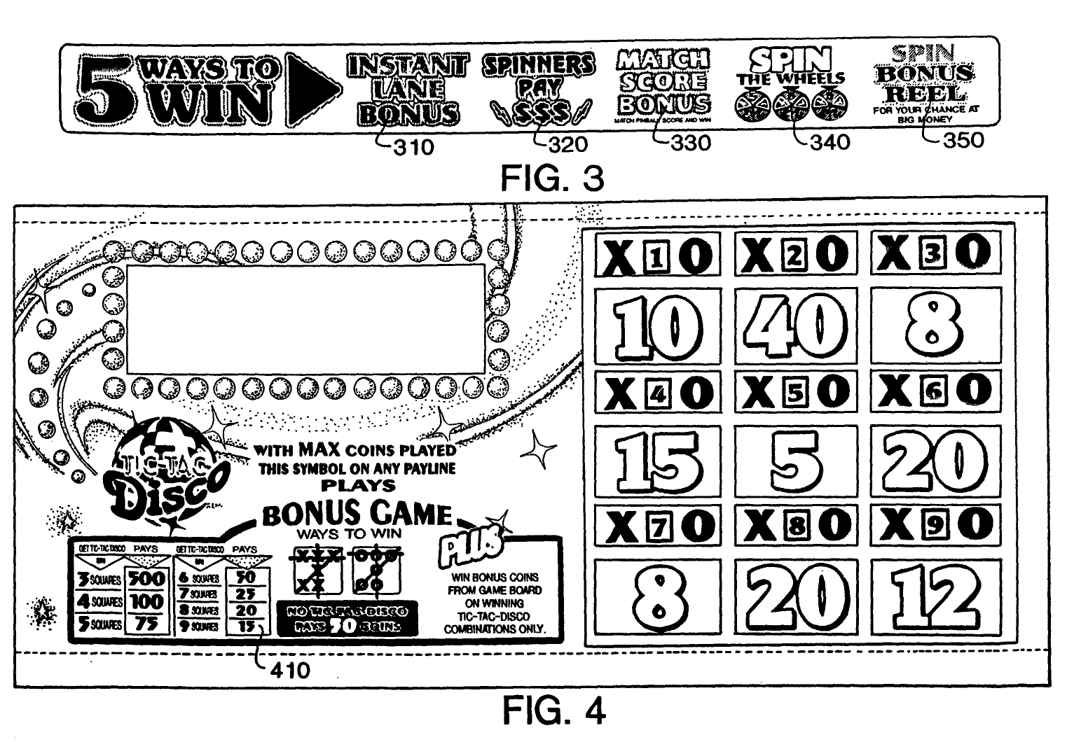

FIG. 3 illustrates another use of the electroluminescent lighting displays on a status display useful with a gaming device. On the illustrated display a first status indicator 310 “INSTANT LANE BONUS” is illuminated when a lane bonus is available to a player. Electroluminescent lighting display 310 is then extinguished when a player qualifies for a second feature and a second electroluminescent lighting display 320 indicating “SPINNERS PAY $$$” is illuminated. Similarly, electroluminescent lighting displays for “MATCH SCORE BONUS” 330, “SPIN THE WHEELS” 340 and “SPIN THE BONUS REEL” 350 are extinguished and illuminated sequentially. FIG. 4 illustrates another aspect of the present invention wherein a display indicator comprises payout indicators 410 which are illuminated with an electroluminescent lighting display when the player wins a specific award.

1. A gaming device which is illuminated differently at different times during the play of the gaming device by a player comprising:
at least one electroluminescent lighting device comprising at least two states of illumination, wherein the state of said electroluminescent lighting device is changed in response to active input by a player.

2. A gaming device according to claim 1 wherein the state of said electroluminescent lighting device is changed in response to at least one event occurring during the play of the gaming device.

3. A gaming device according to claim 1 wherein said active input comprises wagering an amount greater than the minimum amount required to play the gaming device.

4. A gaming device according to claim 1 wherein said active input comprises wagering the maximum wager by a player.

5. A gaming device according to claim 1 wherein said active input comprises player input to change, hold or select a displayed symbol.

6. A gaming device according to claim 1 wherein said active input comprises wagering a portion of winnings during the play mode of a game.

7. A gaming device according to claim 1 wherein said active input comprises the player depressing a button to select at least one of a plurality of options.

8. A gaming device which is illuminated differently at different times during the play of the gaming device by a player comprising:
at least one electroluminescent lighting device comprising at least two states of illumination, wherein the state of said electroluminescent lighting device is changed in conjunction with at least one event occurring during the play mode of the game.

9. A gaming device according to claim 8 wherein said event comprises the activation of a secondary event.

10. A gaming device according to claim 8 wherein said event comprises a win on at least one payline.

11. A gaming device according to claim 8 wherein said event comprises receipt of a randomly determined outcome which qualifies the player for an award.

12. A gaming device which is illuminated differently at different times during the play of the gaming device by a player comprising:
at least one electroluminescent lighting device comprising at least two states of illumination, wherein said electroluminescent lighting device illuminates at least one payline.

13. A gaming device according to claim 12 wherein said electroluminescent lighting device illuminates a plurality of paylines.

14. A gaming device according to claim 12 wherein said electroluminescent lighting device illuminates at least two different paylines with different colors.

15. A gaming device according to claim 8 wherein said electroluminescent lighting device is illuminated in response to input from a player.

16. A gaming device according to claim 8 wherein said event is randomly determined.

17. A gaming device according to claim 1 further comprising:
means for receiving a wager
means for randomly determining at least one of a plurality of possible outcomes, said determining means providing at least one signal corresponding to the determined outcome,
wherein said electroluminescent lighting device is operatively linked to said determining means whereby said electroluminescent lighting device is changed in response to said signal.

18. A gaming device according to claim 8 wherein said electroluminescent lighting device is linked to a display which comprises at least one reel display.

19. A gaming device according to claim 8 wherein said electroluminescent lighting display is linked to a display which comprises at least three reels.

20. A gaming device according to claim 8 wherein said electroluminescent lighting display is linked to a display which comprises a video display.

21. A gaming device according to claim 8 further comprising a secondary gaming unit comprising means for displaying a randomly selected second indicia from a plurality of possible secondary indicia.

22. A gaming device according to claim 21 wherein said secondary gaming unit comprises a wheel.

23. A gaming device according to claim 1 further comprising a secondary gaming unit comprising means for displaying a randomly selected second indicia from a plurality of possible secondary indicia.

24. A gaming device according to claim 23 wherein said secondary unit comprises a wheel.
